(19) United States
(12) Patent Application Publication
(10) Pub. No.: US 2004/0000188 A1
(43) Pub. Date: Jan. 1, 2004

(54) Apparatus and method for hydrostatically testing pipe

(76) Inventor: Thomas J. Mach, Houston, TX (US)

Correspondence Address: James E. Bradley, BRACEWELL & PATTERSON, LLP, P.O. Box 61389, Houston, TX, 77208-1389, US

(21) Appl. No.: 10/186,773

(22) Filed: Jul. 1, 2002

(51) Int. Cl. G01M 3/04

(52) U.S. Cl. 73/49.8

(57) ABSTRACT

A hydrostatic tester for pipe has a frame. A pair of heads are mounted to the frame and spaced apart from each other for receiving a pipe between them. A piston is carried by the frame for moving one of the heads toward the other and holding the heads in abutment with the pipe. Each head has a mandrel, the mandrel having an outer surface that inserts into one of the ends of the pipe. A seal on the outer surface sealingly engages the inner diameter of the pipe. Another seal located on the head sealingly contacts one of the ends of the pipe.

### FIELD OF THE INVENTION

This invention relates in general to equipment for hydrostatically testing pipe, and in particular to heads that abut each end of the pipe to provide a sealed chamber within the pipe.

### DESCRIPTION OF THE PRIOR ART

One type of pipe, particularly utilized in oil field and petrochemical industries, is manufactured by bending steel plate into a cylinder, then welding the seam. It is important to hydrostatically test the pipe after it is manufactured. Often the test must be performed before the pipe is threaded or connectors attached. Often the pipe is 40 feet long or longer and more than a foot in diameter.

Testing these large sections of pipe hydrostatically has in the past been a slow and difficult task. If there are no threads or connectors on the ends, some type of seal has to be placed over the ends in order for the pipe to be tested. One type of sealing arrangement involves placing a rubber hose around the rim of the pipe, then clamping plates against each end. The plates are clamped against the ends by long threaded rods spaced around the pipe being tested, the rods having ends that secure to each of the plates. While workable, assembling the pipe for testing is time-consuming.

### SUMMARY OF THE INVENTION

In this invention, the device that seals against the end of the pipe has a mandrel with a cylindrical outer surface that inserts into the pipe. A seal is located on the outer surface of the mandrel for sealingly engaging an inner diameter of the pipe. There is also an outer seal on the apparatus that engages an exterior portion of the pipe. In the preferred embodiment, the outer seal is located in a groove on a shoulder that extends radially outward from the mandrel. The outer seal abuts against the end of the pipe.

Two of the heads as described are employed for hydrostatically testing pipe. The heads are mounted within a frame. One of the heads is mounted to a support plate that locates at various stops along the frame for different lengths of pipe. The other head mounts to a piston, which in turn is carried by the frame. The piston forces the head and mandrel against one end of the pipe, with the force being transferred through the opposite head and to the support plate and frame.

### BRIEF DESCRIPTION OF THE DRAWINGS

FIG. 1 is a partially schematic top view illustrating a hydrostatic testing device constructed in accordance with this invention.

FIG. 2 is an enlarged sectional view of one of the heads of the device of FIG. 1, shown prior to insertion into a pipe.

FIG. 3 is a sectional view of the head of FIG. 2, shown after insertion into an end of the pipe.

### DESCRIPTION OF THE PREFERRED EMBODIMENT

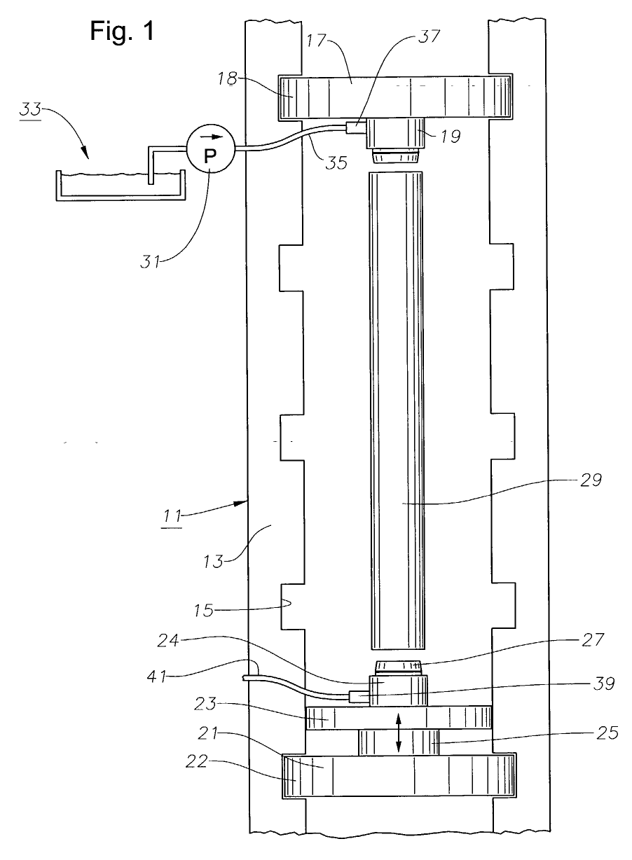

Referring to FIG. 1, the testing device of this invention includes a frame11 that has two parallel vertical side walls 13 and an open top. Side walls 13 have a plurality of vertical recesses or notches 15 formed on their inside surfaces and spaced directly across from each other. Notches 15 are shown to be rectangular in the preferred embodiment and extend from the bottom of frame 11 to the upper edges of side walls 13. A support plate 17 is carried by frame 11 within two oppositely spaced notches 16. Support plate 17 has lugs 18 on its outer edges that slide into notches 15, notches 15 serving as a stop for plate 17. Support plate 17 is in a plane perpendicular to side walls 13. Support plate 17 can be moved into any selected pair of notches 15 to adjust for the length of the pipe to be tested. A head 19 is mounted to the center of support plate 17.

A second support plate 21 is located a selected distance from support plate 17. Support plate 21 also has lugs 22 that will locate in selected notches 15. A carrier plate 23 is located a short distance in front of support plate 21. A piston 25 extends between support plate 21 and carrier plate 23 for advancing and retracting carrier plate 23 relative to support plate 21. Carrier plate 23 is smaller than the dimension between the inside surfaces of side walls 13, therefore will not engage notches 15. Extending piston 25 moves carrier plate 23 toward first support plate 17. Piston 25 needs to be able to extend only about two feet. A head 24 is mounted to carrier plate 23 coaxial with head 19.

Each head 19, 24 has a mandrel 27 that protrudes therefrom, heads 19, 24 being identical in the preferred embodiment. Piston 25 causes heads 19, 24 to abut the ends of a pipe 29 for testing. Mandrels 27 of heads 19, 24 slide into the opposite ends of pipe 29, forming a seal. A pump 31 supplies a liquid, such as water, under high pressure through a line 35 and valve 37 to one of the heads, such as head 19. The liquid is supplied from a water source 33 and flows into the interior of pipe 29 to apply hydrostatic pressure to pipe 29. The opposite head, shown to be head 24 in the drawing, has a drain line 41 connected to head 24 by a valve 39.

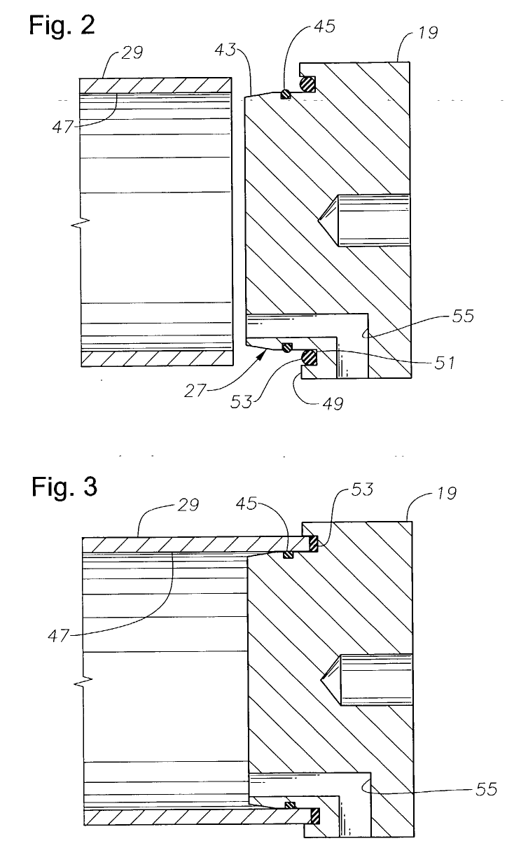

Referring to FIG. 2, mandrel 27 has a beveled or tapered section 43 on its end to facilitate entry into pipe 29. Mandrel 27 has a cylindrical portion rearward of tapered section 43. A seal 45 is located on the cylindrical portion. Seal 45, preferably an O-ring, protrudes from the cylindrical section for sealingly engaging inner diameter 47 of pipe 29.

Head 19 has a shoulder 49 that extends radially outward from the cylindrical portion of mandrel 27. A circular groove 51 surrounds mandrel 27 and contains a seal 53. Seal 53 may be of various elastomeric materials. In the preferred embodiment, it does not protrude forward past groove 51. Seal 53 has approximately the same width as the wall thickness of pipe 29. Seal 53 abuts the end of pipe 29 to provide a backup seal as illustrated in FIG. 3. Passage 55 leads from the exterior of head 19 to the forward face of mandrel 27 for the passage of testing fluid.

In operation, support plates 17, 21 will be positioned at a selected distance from each other to accommodate a pipe 29 between heads 19, 24. Then, piston 25 is actuated to bring heads 19, 24 into abutment with the ends of pipe 29. Mandrels 27 will sealingly engage the interior of pipe 29, forming seals with seal 45 (FIG. 2). Also, seals 53 on heads 19, 24 will abut and sealingly engage the ends of pipe 29. Then, pump 31 is used to fill pipe 29 with liquid. If desired, air may be bled out through valve 39. The pressure from pump 31 is applied until reaching a desired testing amount. Valve 37 may be closed once at the testing pressure. Pipe 29 is inspected along its length for any leakage. After completion, the pressure is bled off and the liquid drained through drain line 41. Then piston 25 is retracted to enable pipe 29 to be removed.

The invention has significant advantages. The testing method and apparatus are much faster than in the prior art. The heads with mandrels provide for sealing both on the inner diameter and the rim or end of the pipe.

While the invention has been shown in only one of its forms, it should be apparent to those skilled in the art that it is not so limited but is susceptible to various changes without departing from the scope of the invention. For example, rather than notches, other types of stops could be provided, such as removable locking bars.

1. An apparatus for sealing an end of a pipe for hydrostatically testing the pipe, comprising:
a mandrel having an outer surface for insertion into a pipe;
an inner seal on the outer surface of the mandrel for sealingly engaging an inner diameter of the pipe; and
an outer seal on the apparatus for engaging an exterior portion of the pipe.

2. The apparatus according to claim 1, further comprising a shoulder that encircles a base of the mandrel, the shoulder being normal to an axis of the mandrel, the outer seal being mounted to the shoulder so that the outer seal engages an end of the pipe.

3. The apparatus according to claim 1, further comprising a shoulder that encircles a base of the mandrel, the shoulder being normal to an axis of the mandrel, the shoulder having a groove in which the outer seal is located so that the outer seal engages an end of the pipe,

4. The apparatus according to claim 1, further comprising a passage extending through the mandrel from an exterior of the apparatus for delivering a pressurized fluid.

5. The apparatus according to claim 1, further comprising a clamp mechanism for holding the mandrel in the pipe as internal fluid pressure is applied to the pipe.

6. An apparatus for hydrostatically testing pipe, comprising:
a frame for holding a section of pipe;
a pair of heads coaxially mounted to the frame and spaced apart from each other for receiving the pipe therebetween;
a piston for moving one of the heads toward the other of the heads and for holding the heads in abutment with ends of the pipe;
a mandrel on each of the heads, each of the mandrels having a cylindrical outer surface for insertion into one of the ends of the pipe;
an inner seal on the outer surface of each of the mandrels for sealingly engaging an inner diameter of the pipe;
an outer seal on each of the heads for sealingly contacting the ends of one of the pipes as the mandrels insert into the pipes; and
a passage in at least one of the heads and at least one of the mandrels for introducing a liquid under pressure into an interior of the pipe.

7. The apparatus according to claim 6, further comprising a shoulder encircling a base of each of the mandrels, the shoulder having an annular groove therein for receiving one of the outer seals.

8. The apparatus according to claim 6, wherein the frame comprises:
a pair of sidewalls;
a plurality of stops located on the sidewalls and extending along a length of the frame, the stops being spaced apart from each other; and
a support plate releasably mounted to selected ones of the stops to provided a selected distance between the heads, one of the heads being mounted to the support plate, and wherein the piston creates a force that passes through the support plate to the sidewalls of the frame.

9. The apparatus according to claim 8, wherein each of the stops comprises a notch formed in the sidewall, the support plate having side edges that locate within the stops.

10. A method for hydrostatically testing pipe, comprising:
mounting a pair of heads coaxially in a frame and spaced apart from each other;
providing a mandrel on each of the heads, each of the mandrels having an outer surface with an inner seal, each of the heads further having an outer seal;
positioning a pipe between the heads;
moving at least one of the heads toward the other, causing the mandrels to enter ends of the pipe, causing the inner seals to sealingly engage interior diameter portions of the pipe, and causing the outer seals to sealingly engage exterior portions of the pipe; then
introducing a liquid under pressure into an interior of the pipe via a passage in at least one of the heads.

11. The method according to claim 10, wherein the outer seals engage the ends of the pipe.
